(19) United States
(12) Patent Application Publication
(10) Pub. No.: US 2004/0222040 A1
(43) Pub. Date: Nov. 11, 2004

(54) Climbing tree stand and cart

(76) Inventor: Jason E. Zirk, Harrisonburg, VA (US)

Correspondence Address: Robert E. Bushnell, Suite 300, 1522 K Street, N.W., Washington, DC, 20005, US

(21) Appl. No.: 10/837,708

(22) Filed: May 4, 2004

Related U.S. Application Data
(60) Provisional application No. 60/469,567, filed on May 9, 2003.

(51) Int. Cl. A01M 31/00

(52) U.S. Cl. 182/136

(57) ABSTRACT

A climbing tree stand includes upper and lower support assemblies for aiding a user in climbing a tree and for supporting the user in the tree. The upper and lower assemblies are attached to the trunk of the tree by straps that wrap around the trunk, and by yokes that are pressed against the trunk in a non-slip manner. The upper assembly having a U-shaped bar forming a foot rest or a rifle rest. The stand having wheels attached to the upper assembly, when the upper and lower assemblies are converted into a cart by attaching the upper and lower assemblies together in a first combination. The wheels being attached to the lower assembly when the upper and lower assemblies are converted into a backpack by attaching the upper and lower assemblies together in a second combination.

This application makes reference to, incorporates the same herein, and claims all benefits accruing under 35 U.S.C. Sec. 119 from my provisional application MULTI-USE HUNTING DEVICE filed with the United States Patent Office on May 9, 2003 and thereby duly assigned Serial No. 60/469,567.

### BACKGROUND OF THE INVENTION

1. Field of the Invention

The present invention relates generally to a climbing tree stand for use by outdoorsmen, such as hunters, naturalists, and photographers and the like, and more particularly to a climbing tree stand which is convertible to a cart for carrying game or equipment and to a frame backpack.

2. Related Art

Platforms and tree stands have long been utilized by outdoorsmen to permit them to acquire an elevated location within a tree. This is particularly advantageous in hunting and a number of devices have been developed and proposed for enabling a person to ascend and descend a tree quickly and safely.

Normally, tree stands are back-packed into the area the hunter has chosen for a still hunt. Hunters often hunt in remote locations which are not easily accessible by motor vehicles, such as all terrain vehicles. The lucky hunter, having packed in his or her equipment and stand, will obtain the object of their desire, such as a deer, and then have to transport all the gear and the heavy deer back to cars. This is a laborious task, especially when one is hunting alone.

Further, some hunting equipment can be heavy and inconvenient to transport to a hunting location. Accordingly, carts are a desirable item to accommodate transporting hunting equipment and returning the hunted game back to the hunters vehicle.

However, transporting a lot of equipment plus a tree stand, sometimes rough terrain, is not real desirable. Accordingly, there have been proposed, a number of tree stands that can be converted into a cart, such as the tree stand known as the “Tree-Lounge” sold at various hunting stores, and from an Internet web site http://commerce.treeloounge.com. The Tree-Lounge has a number of accessories that can be purchased to convert it into different forms for use in gun hunting and bow hunting, and such accessories include wheels so that it can be used as a game/equipment cart.

Other convertible tree stand/cart devices are described in the following U.S. patents: U.S. Pat. No. 5,482,137 to Thomas L. McNeill and titled “Tree Stand”; U.S. Pat. No. 5,492,196 to John L. Michno and titled “Potable Deer Cart And Tree Stand”; U.S. Pat. No. 5,624,008 to Charles E. Beardslee, Jr. and titled “Convertible Tree Stand”; U.S. Pat. No. 5,740,882 to Ricky L. Griffith et al. and titled “Combination Hunting Stand And Game Carrier Apparatus”; U.S. Pat. No. 5,887,676 to Daniel H. Harbin and titled “Accessory For Allowing Use Of A Tree Stand As A Game Cart”; and U.S. Pat. No. 6,481,529 to Berry Kent Voorhies and titled “Climbing Tree Stand.”

### SUMMARY OF THE INVENTION

An object of the present invention is to provide a climbing tree stand having an upper support assembly and a lower support assembly that not only functions as a climbing tree stand, but can be arranged in various configurations, such as to be carried on a user's back or to form a cart.

The upper support assembly includes a frame formed of rectangular tubes to support a readily attachable and removable seat for a user's use. The lower support assembly includes a frame formed of rectangular tubes and includes a plurality of slip resistant slats forming a platform connected to the frame to allow the user to stand.

The upper support assembly and a lower support assembly each include a serrated V-shaped yoke connected to the frame for engaging the trunk of a tree, and each include a respective cable that passes around the trunk of the tree to safely couple the upper support assembly and the lower support assembly to the tree.

The upper support assembly includes a curved bar that is removable and repositionable in order to support the use of the climbing tree stand in its various configurations.

The upper support assembly includes a U-shaped bar formed of a rectangular tube that is removable and repositionable in order to support the use of the climbing tree stand in its various configurations. The U-shaped bar can be used, for example, as a foot rest, a rifle rest or a handle for the cart.

The upper support assembly includes mounting brackets for accepting wheels that are to be utilized when using the climbing tree stand as a cart.

The lower support assembly includes mounting holes for mounting the wheels to the lower support assembly when the climbing tree stand is not being used as a cart, such as when the climbing tree stand is configured to form a back pack.

These and other objects, features, and advantages of the present invention will become more apparent upon reading the following specification in conjunction with the accompanying drawing figures.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIGS. 1a and 1b are top perspective views of the upper support assembly according to the principles of the present invention;

FIG. 2 is a top perspective view of the upper support assembly including attached wheels according to the principles of the present invention;

FIG. 3 is a top perspective view of the lower support assembly according to the principles of the present invention;

FIG. 4 is a side view of the upper and lower support members joined together to form a cart according to the principles of the present invention;

FIG. 5 is a close up view of the positioning of the yokes of the upper and lower support members when the upper and lower support members are joined together to form a cart according to the principles of the present invention;

FIGS. 6a, 6b and 6c illustrate a first embodiment of the upper and lower support members joined together to be transported on a user's back according to the principles of the present invention; and

FIG. 7 illustrates a second embodiment of the upper and lower support members joined together to be transported on a user's back according to the principles of the present invention.

### DETAILED DESCRIPTION OF THE INVENTION

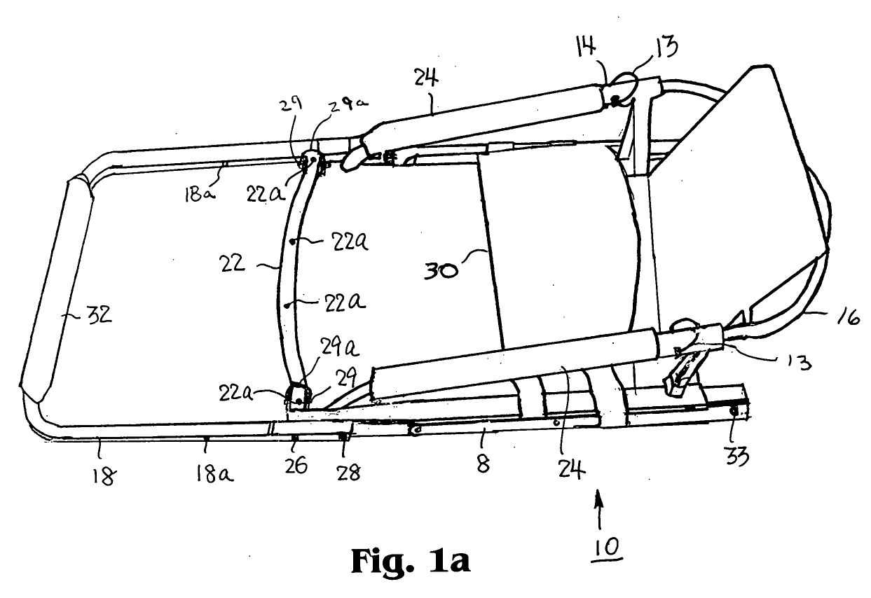

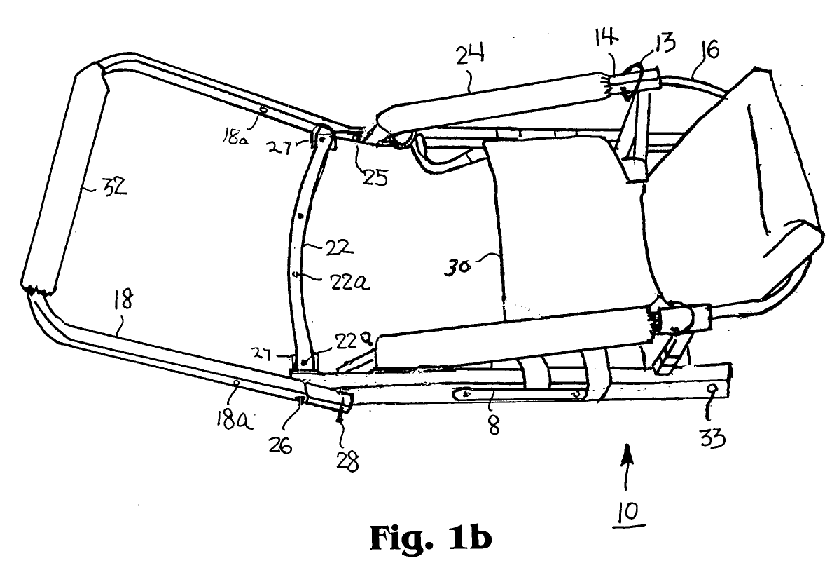

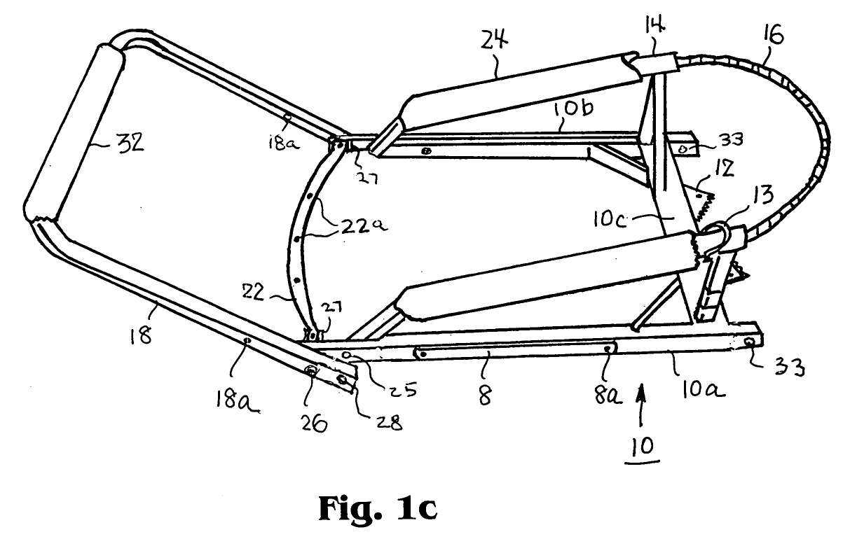

FIGS. 1a and 1b are top perspective views of the upper support assembly comprised of a frame 10 having two longitudinal frame members 10a and 10b welded to a lateral header frame member 10c adjacent to one end of longitudinal frame members 10a and 10b. Longitudinal frame members 10a and 10b extend beyond lateral header frame member 10c and each include an axle hole 33. A seat 30 can be removably attached to frame 10.

A pair of respective angle braces 14 are welded to corresponding ones of the longitudinal frame members 10a and 10b and to lateral header frame member 10c. Pads 24 are removably attachable to angle braces 14 using, for example, hook-and-loop fasteners, snaps or cable ties.

A flexible strap 16 formed by, for example, a covered chain or a steel cable extends between angle braces 14 and are to be wrapped around a tree's trunk when the upper support assembly is to be used as a tree stand. Such a flexible strap is well known in the art as described, for example, in U.S. Pat. No. 5,588,499 to Steven N. Carrier and titled “Tree Stand”, U.S. Pat. No. 5,975,242 to Ronald R. Woller et al. and titled “Climbing Tree Stand With Cable Attachment”, U.S. Pat. No. 6,523,642 to Thomas, E. Graham, Jr. et al. and titled “Adjustable Tree Stand”, U.S. Pat. No. 6,588,546 to Lewis Forrest and entitled “Tree Stand”, U.S. Pat. No. 6,595,325 to Bruce E. Ulrich and titled “Tree Stand With Level Adjustment”, and Voorhies U.S. Pat. No. 6,481,529 discussed earlier.

Quick-clip pins (or other types of fasteners or pins such as ball lock pins, detent pins, expanding pins, etc.) 13 are used to secure the strap 16 in a desired adjusted position such that frame 10 forms an acute angle to the tree's trunk.

Attached to lateral header frame member 10c is a V-shaped yoke 12 having serrated teeth for engaging a tree's trunk in a non-slip manner when the upper support assembly is attached to the tree's trunk. Such a yoke 12 is known in the art as described in several of the foregoing patents.

Longitudinal frame members 10a and 10b include mounting brackets 27 on ends distal to axle holes 33. Mounting brackets 27 allow for a curved bar 22 to be laterally mounted between longitudinal frame members 10a and 10b. Curved bar 22 contains several through holes 22a, the outer most pairs of through holes 22a being used to secure the curved bar 22 to mounting brackets 27 by means of quick-clip pins (or other types of fasteners or pins such as ball lock pins, detent pins, expanding pins, etc.) 29, 29a.

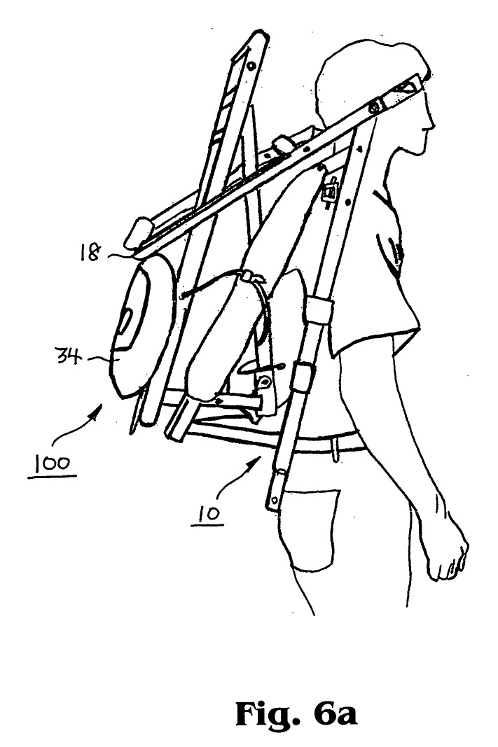

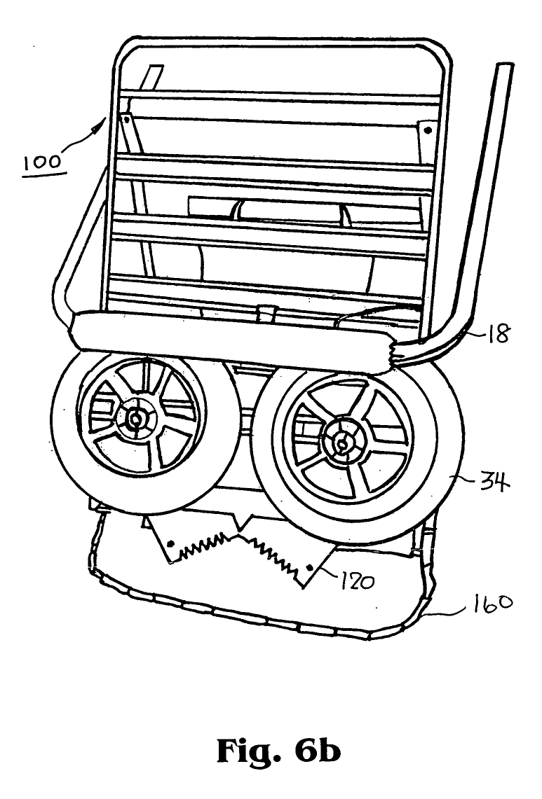

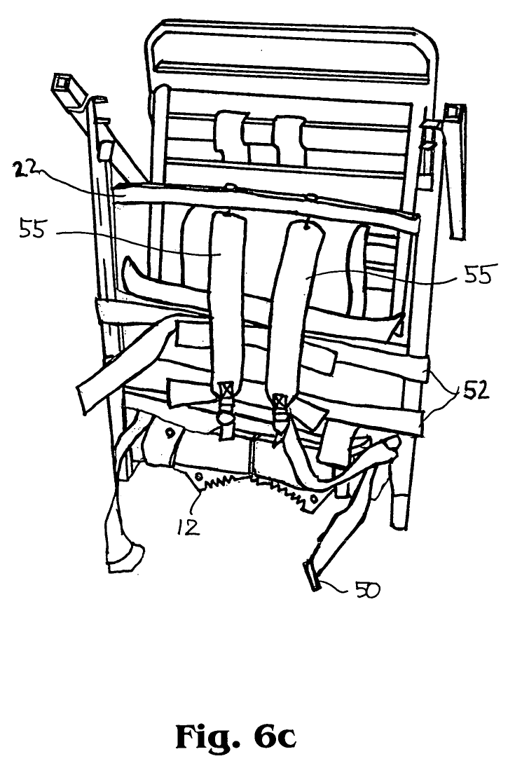

Curved bar 22 has a concavity that curves away from a user's knees when the user is seated in seat 10. This will be referred to hereafter as the “initial position” of curved bar 22, and is the illustrated position. From this initial position, curved bar 22 can be rotated 90 degrees counterclockwise, if desired, for a user to sit on when ascending or descending a tree, however, the curved bar 22 does not need to be rotated out of its initial position when performing these acts. Curved bar 22 can be rotated 90 degrees from its initial position clockwise so that the concavity faces a user's back, or moved to a different position as will be discussed below with respect to FIGS. 6a-6c, when the tree stand is configured to be carried on the user's back. A pad 20 is removably attachable to curved bar 22 using, for example, hook-and-loop fasteners, snaps or cable ties.

The upper support assembly includes a U-shaped bar 18 that is removable and repositionable in order to support the use of the climbing tree stand in its various configurations. The U-shaped bar 18 can be used, for example, as a foot rest, a rifle rest or a handle for the cart. The arms forming the open end U-shaped bar 18 each include at least three through holes 18a, two of which holes 18a, align with a pair of holes 25 in longitudinal frame members 10a and 10b. Quick-clip pins (or other types of fasteners or pins such as ball lock pins, detent pins, expanding pins, etc.) 26 and 28 are provided to pass through holes 18a and 25 to attach the U-shaped bar 18 to longitudinal frame members 10a and 10b.

As shown in FIGS. 1a and 1b, a long flat bar 8 having holes 8a in either end is rotatably mounted at one end to longitudinal frame member 10a. Flat bar 8 can be rotated to be attached to U-shaped bar 18 using quick-clip pin 28 and one of the free holes 18a to hold the U-shaped bar 18 in a desired rotated position, such as when used as a foot rest or as an rifle rest (a.k.a. shooting rest). A similar flat bar (not shown) will is provided on longitudinal frame member 10b. A pad 32 is removably attachable to the lateral portion of U-shaped bar 18 using, for example, hook-and-loop fasteners, snaps or cable ties.

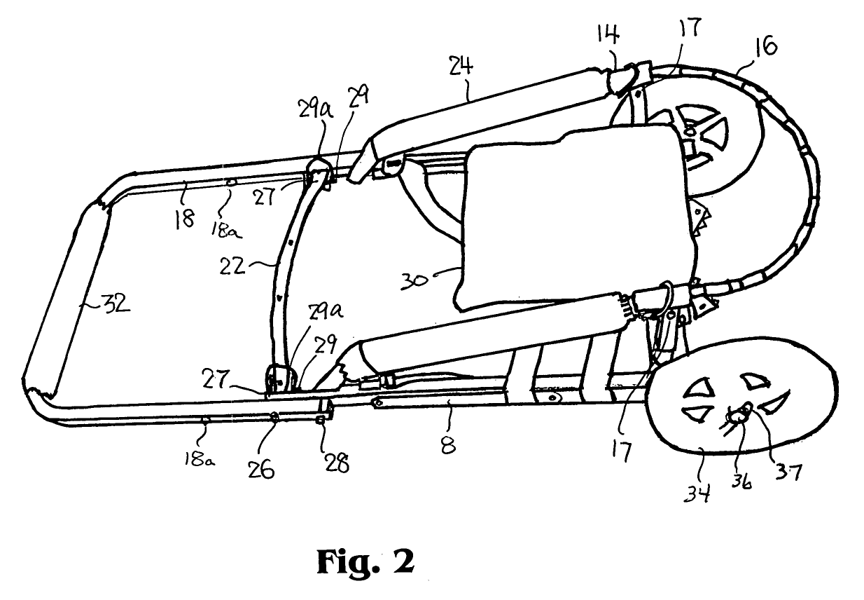

As shown in FIG. 2, a pair of wheels 34 are provided to be mounted to axle holes 33 when using the tree stand as a cart. Axle pins 36 are inserted through axle holes 33 and wheels 34, and are secured in position by cotter pins 37 passing through one end of the shaft of axle pins 36.

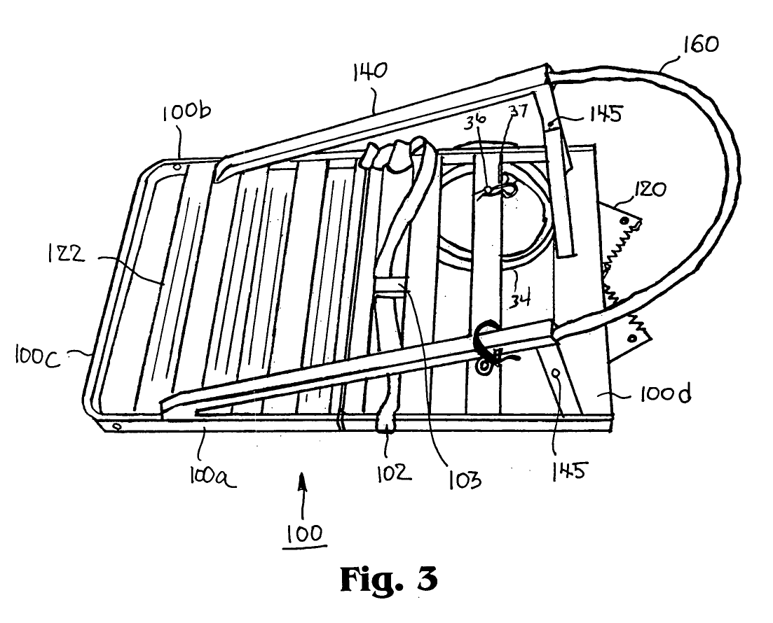

FIG. 3 is a top perspective view of the lower support assembly comprised of a frame 100 having two longitudinal frame members 100a and 100b, and a lateral frame member 100c.

A lateral header frame member 100d is welded to one end of longitudinal frame members 100a and 100b. A pair of respective angle braces 140 are welded to corresponding ones of the longitudinal frame members 100a and 100b and to lateral header frame member 100d.

A flexible strap 160 formed by, for example, a covered chain or a steel cable extends between angle braces 140 and are to be wrapped around a tree's trunk when the lower support assembly is to be used as a tree stand.

Attached to lateral header frame member 100d is a V-shaped yoke 120 having serrated teeth for engaging a tree's trunk in a non-slip manner when the lower support assembly is attached to the tree's trunk.

A plurality of molded slats 122 extend laterally between and are welded to longitudinal frame members 100a and 100b and form a platform upon which a user can stand. Slats 122 are coated with a non-slip material. A box shaped bracket 103 is mounted between a pair of slats 122 and an adjustable foot strap 102 passes through bracket 103 and is secured to longitudinal frame members 100a and 100b. A user will insert his/her feet through loops formed by strap 102 to assist the user to move the lower support assembly up and down the tree when using the tree stand to climb up or down the tree, as is well known in the art.

One of the slats 122 include wheel mounting holes so that wheels 134 can be removably attached to the lower support assembly when not being attached to the upper support assembly. This provides a convenient way to carry the wheels 134 when the tree stand is configured to be carried on a user's back.

Quick-clip pins (or other types of fasteners or pins such as ball lock pins, detent pins, expanding pins, etc.) 130 are used to secure the strap 160 in a desired adjusted position such that frame 100 is as nearly parallel to frame 10 as possible.

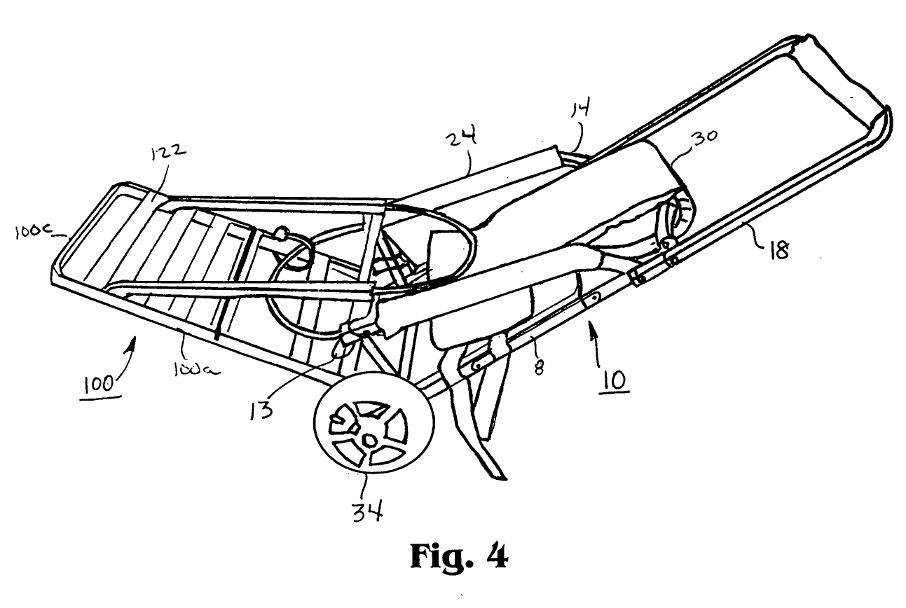

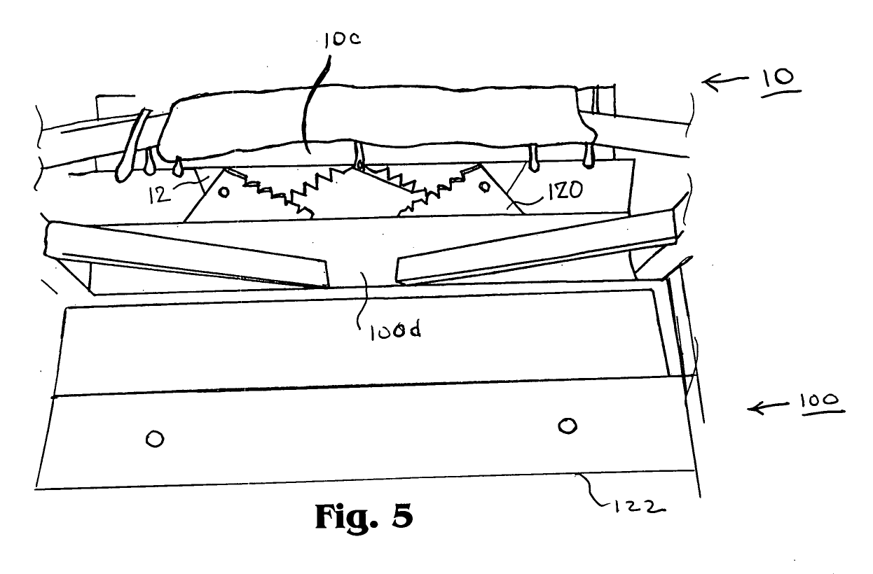

FIG. 4 is a side view of the upper and lower support members joined together to form a cart. Angle braces 140 fit inside angle braces 14, and are pinned to angle braces 14 using quick-clip pins 13 passing through cart assembly holes 17 (FIGS. 1a, 1b and 2) in angle braces 14 and cart assembly holes 145 (FIG. 3) in angle braces 140. In this position, yokes 120 rest on top of yokes 12 as shown in FIG. 5. Additionally, U-shaped bar 18 becomes a handle for the user to maneuver the cart. In the cart mode the tree stand can be used to transport equipment to and from a desired location. Or, if desired the tree stand can be converted into a backpack mode to be described below.

FIGS. 6a, 6b and 6c illustrate a first embodiment of the upper and lower support members joined together to be transported on a user's back. The upper and lower support members are meshed together such that angle braces 140 fit between angle braces 14: The upper and lower support members are connected together by straps 52 and a gap is formed between frame 10 and frame 100. A storage pack or other equipment can be disposed in the created gap.

In the illustrated configuration of the first embodiment, frame 10 is closest to the user's back, and yokes 12 and 120 point toward the ground. As shown in FIG. 6b the wheels 34 are mounted to the lower support assembly.

As shown in FIG. 6c, curved bar 22 has been moved from it initial position to be aligned between holes 25, and is thus mounted between longitudinal frame members 10a and 10b using quick-clip pins 28, other type pins, such as ball lock pins, detent pins, expanding pins, or other type fasteners. In this position, the concavity of curved bar 22 faces towards the user's back. Additionally, quick-clip pins 28 no longer hold U-shaped bar 18, thus U-shaped bar 18 is rotated over frame 100 and rests on top of wheels 34 as shown in FIG. 6b. Note here that it may be desired to include additional mounting brackets, such as mounting brackets 27, on longitudinal frame members 10a and 10b adjacent to holes 25.

A webbed belt 50 is attached to frame 10 at any desired location so that it comfortably fit around the user's waist. The belt can be padded, or not. A pair of shoulder straps 55 are attached at one end to curved bar 22, and preferably utilize through holes 22a. The other end of shoulder straps 55 can be attached to frame 10 or straps 52. Additionally, the shoulder straps 55 and belt 50 can be a single unit that is attachable to frame 10.

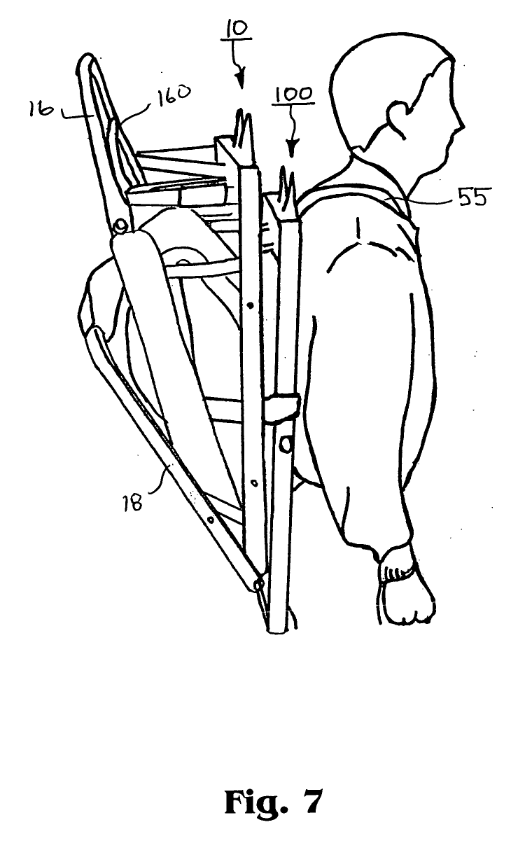

FIG. 7 illustrates a second embodiment of the upper and lower support members joined together to be transported on a user's back. The upper and lower support members are meshed together such that angle braces 140 fit between longitudinal frame members 10a and 10b and project away from the user's back in the same manner as angle braces 14. The upper and lower support members are connected together by straps, and a storage pack is attached to frame 10 in the space between longitudinal frame members 10a and 10b.

In the illustrated configuration of the second embodiment, frame 100 is closest to the user's back, and yokes 12 and 120 point upward. In this case, the shoulder straps 55 are connected to lateral header frame member 100d at one end at to longitudinal frame members 100a and 100b at the other end. Belt 50 will also be attached to longitudinal frame members 100a and 100b or lateral frame member 100c. Wheels 34 will rest against the user's back, and pads can be provided for cushioning the wheels for more comfort.

Note here that the upper support assembly, for example, could be used as a frame for a backpack without the need for using the lower support assembly, wherein a pack could be attached to the frame in any number of ways.

The invention has been described with particular embodiments thereof, however, various changes and modifications can be made therein without departure from the scope of the appended claims. For example, the wheels, curved bar, pack, straps, etc. can be provided is a separate kit sold from the upper and lower support assemblies. Such a kit could be used to modify some existing climbing tree stands.

Additionally, the free ends of U-shaped bar 18 could slip inside longitudinal frame members 10a and 10b. Or a ratchet connection could be provided to connect U-shaped bar 18 to frame 10, such a ratchet connection allowing U-shaped bar 18 to be set in any desired position between and including foot rest or rifle rest positions.

Other means besides flat bars 8 may be provided to hold U-shaped bar 18 in a desired position such as the foot rest or rifle rest position.

Also, similar to the upper support assembly, the longitudinal frame members 100a and 100b of the lower support assembly could be elongated for mounting the wheels for the cart. In such a case, yoke 12 will rest on top of yoke 120. And U-shaped bar 18 could be attached to the lower support assembly to be used as a handle.

Wheels 34 could be mounted to any of the frame members 10a, 10b, 100a, 100b or 100c, or to angle braces 14 or 140, when not in use for the cart.

1. A climbing tree stand having upper and lower support assemblies that can be connected in various combinations to change from a tree stand to a cart or a backpack, said upper support assembly comprising:
a first frame formed of a pair of first longitudinal frame members and a first lateral header frame member attached between said first longitudinal frame members at a first end of said first longitudinal frame members, said first longitudinal frame members having portions extending beyond said first lateral header frame member;
a pair of first angle braces connected to said first lateral header frame member and to respective ones of said first longitudinal frame members;
a first flexible cable removably and adjustably connected between said first angel braces, said first flexible cable being wrapped around a trunk of a tree when said upper support assembly is attached to the tree;
a first yoke attached to said first lateral header frame member, said first yoke engaging said tree trunk in a non-slip fashion when said upper support assembly is attached to the tree; and
first wheel mounting holes formed in said portions of said first longitudinal frame members extending beyond said first lateral header frame member, wherein wheels are mounted to said first wheel mounting holes when said upper and lower support assemblies are combined to form said cart.

2. The climbing tree stand as set forth in claim 1, said upper support assembly comprising:
mounting brackets attached to said longitudinal frame members at a second end of said longitudinal frame members distal to said first end; and
a curved lateral frame member connected between said mounting brackets, said curved lateral frame member having a concavity facing towards a user's knees when said user is seated in said upper support assembly when said curved lateral frame member is mounted between said mounting brackets in a first orientation, said curved lateral frame member being rotatable to at least a second orientation 90 degrees different from said first orientation.

3. The climbing tree stand as set forth in claim 2, said curved lateral frame member being repositioned to a second position between said first longitudinal frame members and being oriented to have said concavity facing the user's back when said upper and lower support assemblies are combined to form said backpack, said second position being between said first and second ends of said first longitudinal frame members.

4. The climbing tree stand as set forth in claim 1, said upper support assembly comprising:
a curved lateral frame member removably connected between said longitudinal frame members at a second end of said longitudinal frame members distal to said first end, said curved lateral frame member having a concavity facing towards a user's knees when said user is seated in said upper support assembly; and
said curved lateral frame member being repositioned to a second position between said first longitudinal frame members and being oriented to have said concavity facing the user's back when said upper and lower support assemblies are combined to form said backpack, said second position being between said first and second ends of said first longitudinal frame members.

5. The climbing tree stand as set forth in claim 4, further comprising:
a belt connected to said first frame; and
a pair of shoulder harnesses connected between said curved lateral frame member and said first frame when said upper and lower support assemblies are combined to form said backpack.

6. The climbing tree stand as set forth in claim 1, said upper support assembly comprising:
a U-shaped bar rotatably attached to said longitudinal frame members at a second end of said longitudinal frame members distal to said first end, said U-shaped bar forming a handle for said cart when said upper and lower support assemblies are combined to form said cart, said U-shaped bar forming either one of a foot rest and a rifle rest when said upper and lower support assemblies are mounted to the tree as a tree stand; and
means mounted on respective ones of said pair of first longitudinal frame members, said means being connectable to said U-shaped bar to hold said U-shaped bar in position as said foot rest or said rifle rest.

7. The climbing tree stand as set forth in claim 1, said lower support assembly comprising:
a second frame comprising:
a pair of second longitudinal frame members;
a second lateral header frame member attached between said second longitudinal frame members at a first end of said second longitudinal frame members; and
a lateral frame member connecting said second longitudinal frame members at a second end of said second longitudinal frame members distal to said first end;
a pair of second angle braces connected to said second lateral header frame member and to respective ones of said second longitudinal frame members;
a second flexible cable removably and adjustably connected between said second angel braces, said second flexible cable being wrapped around the trunk of said tree when said lower support assembly is attached to the tree;
a second yoke attached to said second lateral header frame member, said second yoke engaging said tree trunk in a non-slip fashion when said lower support assembly is attached to the tree; and
a plurality of slats laterally disposed between said second longitudinal frame members, one of said slats having second wheel mounting holes, wherein wheels are mounted to said second wheel mounting holes when said upper and lower support assemblies are combined to form said backpack.

8. The climbing tree stand as set forth in claim 7, said lower support assembly comprising:
first cart assembly holes formed in said first angle braces and second cart assembly holes formed in said second angle braces; and
a pair of fasteners inserted through said first and second cart assembly holes when said upper and lower support assemblies are combined to form said cart.

9. The climbing tree stand as set forth in claim 8, further comprising:
said second yoke resting on a top surface of said first yoke when said upper and lower support assemblies are combined to form said cart.

10. The climbing tree stand as set forth in claim 7, said second angle braces being nested between said first angle braces when said upper and lower support assemblies are combined to form said backpack, such that a bottom surface of said first frame is adjacent to the user's back and a bottom surface of said second frame is facing away from said user's back, a gap being formed between said first frame and said second frame; and
a pack disposed within said gap.

11. A climbing tree stand having upper and lower support assemblies that can be connected in various combinations to change from a tree stand to a cart or a backpack, said upper support assembly having a first frame and said lower support assembly having a second frame, said first frame comprising:
a pair of first longitudinal frame members and a first lateral header frame member attached between said first longitudinal frame members at a first end of said first longitudinal frame members, said first longitudinal frame members having portions extending beyond said first lateral header frame member for receiving a pair wheels when said upper and lower support assemblies are combined to form said cart;
mounting brackets attached to said longitudinal frame members at a second end of said longitudinal frame members distal to said first end; and
a curved lateral frame member removably connected between said mounting brackets, said curved lateral frame member having a concavity facing towards a user's knees when said user is seated in said upper support assembly, said curved lateral frame member being repositioned to a second position between said first longitudinal frame members and being oriented to have said concavity facing the user's back when said upper and lower support assemblies are combined to form said backpack, said second position being between said first and second ends of said first longitudinal frame members.

12. The climbing tree stand as set forth in claim 11, said upper support assembly comprising:
a U-shaped bar rotatably attached to said first longitudinal frame members at a second end of said first longitudinal frame members distal to said first end, said U-shaped bar forming a handle for said cart when said upper and lower support assemblies are combined to form said cart, said U-shaped bar forming either one of a foot rest and a rifle rest when said upper and lower support assemblies are mounted to the tree as a tree stand; and
means rotatably mounted to respective ones of said pair of first longitudinal frame members, said means being connectable to said U-shaped bar to hold said U-shaped bar in position as said foot rest or said rifle rest.

13. The climbing tree stand as set forth in claim 11, said second frame comprising:
a pair of second longitudinal frame members;
a second lateral header frame member attached between said second longitudinal frame members at a first end of said second longitudinal frame members; and
a lateral frame member connecting said second longitudinal frame members at a second end of said second longitudinal frame members distal to said first end.

14. The climbing tree stand as set forth in claim 13, said upper support assembly further comprising:
a pair of first angle braces connected to said first lateral header frame member and to respective ones of said first longitudinal frame members;
a first flexible cable removably and adjustably connected between said first angel braces, said first flexible cable being wrapped around a trunk of a tree when said upper support assembly is attached to the tree;
a first yoke attached to said first lateral header frame member, said first yoke engaging said tree trunk in a non-slip fashion when said upper support assembly is attached to the tree; and
first wheel mounting holes formed in said portions of said first longitudinal frame members extending beyond said first lateral header frame member, wherein wheels are mounted to said first wheel mounting holes when said upper and lower support assemblies are combined to form said cart.

15. The climbing tree stand as set forth in claim 14, said lower support assembly further comprising:
a pair of second angle braces connected to said second lateral header frame member and to respective ones of said second longitudinal frame members;
a second flexible cable removably and adjustably connected between said second angel braces, said second flexible cable being wrapped around the trunk of said tree when said lower support assembly is attached to the tree;
a second yoke attached to said second lateral header frame member, said second yoke engaging said tree trunk in a non-slip fashion when said lower support assembly is attached to the tree; and
a plurality of slats laterally disposed between said second longitudinal frame members, one of said slats having second wheel mounting holes, wherein wheels are mounted to said second wheel mounting holes when said upper and lower support assemblies are combined to form said backpack.

16. The climbing tree stand as set forth in claim 15, said lower support assembly comprising:
first cart assembly holes formed in said first angle braces and second cart assembly holes formed in said second angle braces; and
a pair of fasteners inserted through said first and second cart assembly holes when said upper and lower support assemblies are combined to form said cart.

17. The climbing tree stand as set forth in claim 16, further comprising:
said second yoke resting on a top surface of said first yoke when said upper and lower support assemblies are combined to form said cart.

18. The climbing tree stand as set forth in claim 15, said second angle braces being nested between said first angle braces when said upper and lower support assemblies are combined to form said backpack, such that a bottom surface of said first frame is adjacent to the user's back and a bottom surface of said second frame is facing away from said user's back, a gap being formed between said first frame and said second frame; and
a pack disposed within said gap.

19. The climbing tree stand as set forth in claim 15, said upper support assembly comprising:
a U-shaped bar rotatably attached to said first longitudinal frame members at said second end of said first longitudinal frame members distal to said first end, said U-shaped bar forming a handle for said cart when said upper and lower support assemblies are combined to form said cart, said U-shaped bar forming either one of a foot rest and a rifle rest when said upper and lower support assemblies are mounted to the tree as a tree stand; and
means rotatably mounted to respective ones of said pair of first longitudinal frame members, said means being connectable to said U-shaped bar to hold said U-shaped bar in position as said foot rest or said rifle rest.

20. The climbing tree stand as set forth in claim 15, said upper support assembly comprising:
a belt connected to said first frame; and
a pair of shoulder harnesses connected between said curved lateral frame member and said first frame when said upper and lower support assemblies are combined to form said backpack.
